(19) United States
(12) Patent Application Publication
(10) Pub. No.: US 2023/0290341 A1
(43) Pub. Date: Sep. 14, 2023

(54) UTTERANCE UNDERSTANDING SUPPORT SYSTEM, METHOD, DEVICE AND PROGRAM

(71) Applicant: NIPPON TELEGRAPH AND TELEPHONE CORPORATION, Tokyo (JP)

(72) Inventors: Tsuyoshi OGURA, Musashino-shi, Tokyo (JP); Masanori OGAWARA, Musashino-shi, Tokyo (JP); Takahiro YAMAGUCHI, Musashino-shi, Tokyo (JP)

(73) Assignee: NIPPON TELEGRAPH AND TELEPHONE CORPORATION, Tokyo (JP)

(21) Appl. No.: 18/013,499

(22) PCT Filed: Jul. 3, 2020
(86) PCT No.: PCT/JP2020/026249

§ 371 Date: Dec. 28, 2022

(51) Int. Cl. G10L 15/18; G10L 15/26

(52) U.S. Cl. CPC G10L 15/1815; G10L 15/26

(57) ABSTRACT

An object of the present invention is to provide a system having a function of, in a case where there is ambiguity of being incapable of specifying an entity or content referred to by a noun or a noun equivalent expression in utterance exchanged in a communication system via a computer network, searching for accurate meaning or information serving as a clue to understand the meaning using only information regarding an utterance sentence or an utterer as a clue, instead of a response to a question sentence created by a user, and presenting a result to the user.

The present disclosure is a communication system via a computer network, making it possible to specify an entity of a noun including ambiguity in utterance on the grounds of background knowledge based on content of an accumulated document file group, and clearly indicate the entity to the user by including: an utterance sentence analysis unit that inputs, by text input, an utterance by a user who is a communication participant, and performs structural analysis of each utterance sentence having been input and context analysis based on an utterance history; an ambiguous portion designation function for a user to designate a portion when the user finds ambiguity with respect to an entity referred to by a noun in an utterance; a background knowledge extraction unit that refers to content of a document file group created and accumulated by various activities by a user who participates in or is likely to participate in communication, and extracts information to be background knowledge of the communication; a background knowledge database that holds, in a form of database, background knowledge extracted by the background knowledge extraction unit; a database search unit that searches the background knowledge database for specifying an entity referred to by a noun designated by the ambiguous portion designation function; and a content explanation display unit that displays, only to a user who has performed the ambiguity designation, information describing an entity referred to by the noun designated to be ambiguous, the entity being specified by a result of search by the database search unit.

### TECHNICAL FIELD

The present invention relates to a technology for performing communication via text and voice on a computer network.

### BACKGROUND ART

Conventional communication technologies on a computer network via text and voice include a chat system and a voice conference system. These systems transfer, via text and voice, utterance sentences uttered by users participating in communication as they are.

In a case where there is an ambiguous expression or a matter for which a specific target cannot be specified in the utterer's utterance, it is necessary to take an action such as asking the utterer about the accurate meaning of the utterance or acquiring information to help understanding by searching using handheld materials or a computer. However, in an actual communication situation, there are a case of not capable of taking such an action, a case of not capable of asking back the utterer on the spot even if the action is taken, a case of taking time and effort in searching, and the like, and there is a problem that the listener remains incapable of understanding the accurate content of the utterance.

### CITATION LIST

### Non Patent Literature

Non Patent Literature 1: Manabu Okumura, “Introduction to Natural Language Processing”, Corona Publishing Co., Ltd., pp. 125 to 133
Non Patent Literature 2: Manabu Okumura, “Introduction to Natural Language Processing”, Corona Publishing Co., Ltd., pp. 133 to 137
Non Patent Literature 3: Manabu Okumura, “Introduction to Natural Language Processing”, Corona Publishing Co., Ltd., pp. 84 to 95
Non Patent Literature 4: NTT TechnoCross Corporation, SpeechRec, www.v-series.jp/speechrec/

### SUMMARY OF INVENTION

### Technical Problem

An object of the present invention is to provide a system having a function of, in a case where there is ambiguity of being incapable of specifying an entity or content referred to by a noun or a noun equivalent expression in utterance exchanged in a communication system via a computer network, searching for accurate meaning or information serving as a clue to understand the meaning using information regarding an utterance sentence or an utterer as a clue, and presenting a result to a user.

### Solution to Problem

An utterance understanding support system according to the present invention is a communication system via a computer network and includes:
a background knowledge extraction unit that refers to content of a file group of a management target area including a document file created or accumulated by an activity of a communication participant, and extracts information serving as background knowledge of communication;
a background knowledge database that holds, in a form of database, background knowledge extracted by the background knowledge extraction unit;
an utterance sentence analysis unit that performs structural analysis of each utterance sentence having been input and context analysis based on an utterance history when an utterance by a user who is a communication participant is input by text input;
an ambiguous portion designation function for a user to designate a part of the utterance as an ambiguous portion;
a database search unit that searches the background knowledge database for specifying an entity referred to by a noun included in the ambiguous portion; and
a user interface application that displays, on a screen, information describing an entity referred to by a noun included in the ambiguous portion, the entity being specified by a result of the search.

An utterance understanding support device according to the present invention includes:
an utterance sentence analysis unit that performs structural analysis of each utterance sentence having been input and context analysis based on an utterance history when an utterance by a user who is a communication participant is input by text input;
a database search unit that searches a background knowledge database in which background knowledge of communication is held in a form of database in order to specify an entity referred to by a noun included in an ambiguous portion when a part of an utterance sentence by a communication participant is designated as the ambiguous portion in a client terminal that is a communication participant; and
a user interface application that displays, on a client terminal in which the ambiguous portion is designated, information describing an entity referred to by the ambiguous portion, the entity being specified by a result of search by the database search unit.

In an utterance understanding support method according to the present invention includes:
an utterance sentence analysis unit performing structural analysis of each utterance sentence having been input and context analysis based on an utterance history when an utterance by a user who is a communication participant is input by text input;
a database search unit searching a background knowledge database in which background knowledge of communication is held in a form of database in order to specify an entity referred to by a noun included in the ambiguous portion when a part of an utterance sentence by a communication participant is designated as an ambiguous portion in a client terminal that is a communication participant; and
a user interface application displaying, on a client terminal in which the ambiguous portion is designated, information describing an entity referred to by the ambiguous portion, the entity being specified by a result of search by the database search unit.

An utterance understanding support program according to the present invention is a program for causing a computer to implement:
an utterance sentence analysis unit that performs structural analysis of each utterance sentence having been input and context analysis based on an utterance history when an utterance by a user who is a communication participant is input by text input;
a database search unit that searches a background knowledge database in which background knowledge of communication is held in a form of database in order to specify an entity referred to by a noun included in an ambiguous portion when a part of an utterance sentence by a communication participant is designated as the ambiguous portion in a client terminal that is a communication participant; and
a user interface application that displays, on a client terminal in which the ambiguous portion is designated, information describing an entity referred to by the ambiguous portion, the entity being specified by a result of search by the database search unit.

### Advantageous Effects of Invention

According to the present invention, an entity of a noun including ambiguity in utterance can be specified on the grounds of background knowledge based on content of an accumulated document file group, and can be clearly indicated to the user. Therefore, even in a case where an utterance has a portion whose accurate meaning cannot be understood, and the user cannot directly ask the utterer a question, a case where the utterer cannot give an answer, or a case where it takes time and effort to search for related information, accurate meaning and content or information serving as a clue to understand the accurate meaning and content can be obtained. Therefore, mutual understanding of the users in a communication system via a computer network is facilitated, and smooth communication can be achieved.

### BRIEF DESCRIPTION OF DRAWINGS

FIG. 1 is a view illustrating a communication system of the present invention.

FIG. 2 is a view illustrating a configuration of a display screen of the communication system of the present invention.

FIG. 3 is a view illustrating an overall configuration of a first embodiment for carrying out the invention.

FIG. 4 is a view illustrating a structure of a file attribute table of a background knowledge database.

FIG. 5 is a view illustrating a structure of a named-entity extraction information table of the background knowledge database.

FIG. 6 is a view illustrating a structure of a summarization information table of the background knowledge database.

FIG. 7 is a view illustrating a structure of a full-text search auxiliary information table of the background knowledge database.

FIG. 8 is a view illustrating a flow of preprocessing of the background knowledge database.

FIG. 9 is a view illustrating information used for searching the background knowledge database.

FIG. 10 is a view illustrating a flow of search processing of the background knowledge database.

FIG. 11 is a view illustrating a flow of search processing of a file attribute table.

FIG. 12A is a view illustrating a flow of search processing of a named-entity extraction information table.

FIG. 12B is a view illustrating a flow of search processing of the named-entity extraction information table.

FIG. 13A is a view illustrating a flow of search processing of a summarization information table.

FIG. 13B is a view illustrating a flow of search processing of the summarization information table.

FIG. 14A is a view illustrating a flow of search processing of a full-text search auxiliary information table.

FIG. 14B is a view illustrating a flow of search processing of the full-text search auxiliary information table.

FIG. 15 is a view illustrating a configuration of a content display unit in a third embodiment for carrying out the invention.

### DESCRIPTION OF EMBODIMENTS

Embodiments of the present disclosure will be described in detail below with reference to the drawings. Note that the present disclosure is not limited to the following embodiments. These embodiments are merely examples, and the present disclosure can be carried out in a form with various modifications and improvements based on the knowledge of those skilled in the art. Note that components having the same reference numerals in the present description and the drawings indicate the identical components.

### Outline of Present Disclosure

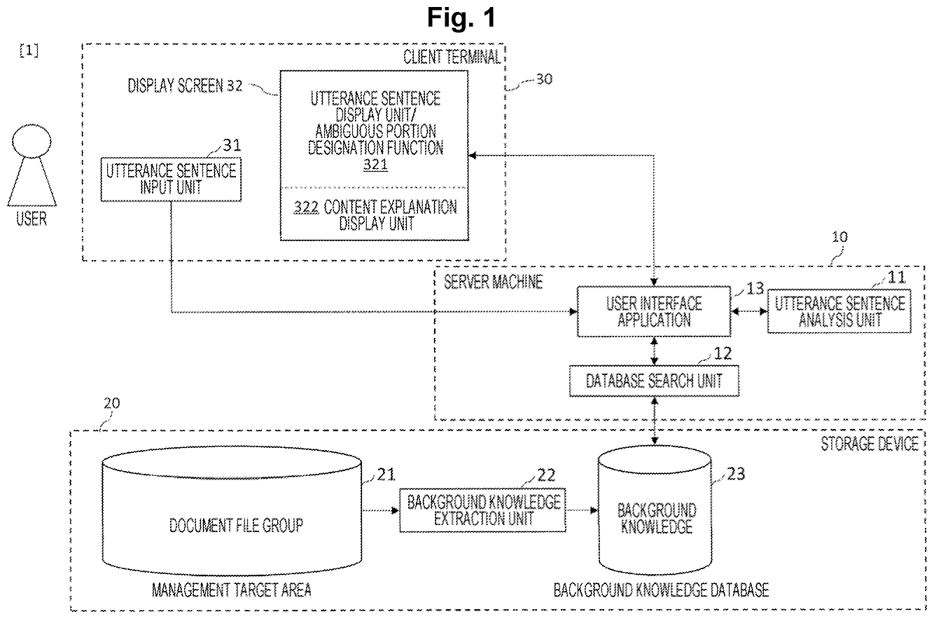

An utterance understanding support system of the present disclosure is a communication system via a computer network, and includes an ambiguous portion designation function, an utterance sentence analysis unit, a background knowledge extraction unit, a background knowledge database, a database search unit, and a content explanation display unit. FIG. 1 illustrates an example of an utterance understanding support system of the present invention that has these means.

The communication system of the present disclosure includes a server machine 10, a storage device 20, and a client terminal 30, and executes an utterance understanding support method. The client terminal 30 is a terminal used by the user, and is connected to a computer network. The server machine 10 is connected to the client terminal 30. The storage device 20 is connected to the server machine 10. The server machine 10, the storage device 20, and the client terminal 30 can also be implemented by a computer and a program, and the program can be recorded in a recording medium or provided through a network.

Each user of the present system participates in communication via the client terminal 30 occupied by the user. The client terminal 30 includes an utterance sentence input unit 31 that inputs utterance of each user and a display screen 32 serving as an interface. The display screen 32 includes an utterance sentence display unit 321 that displays an utterance sentence of each user and a content explanation display unit 322. The utterance sentence display unit 321 holds an ambiguous portion designation function for the user to designate a word appearing therein having an ambiguous entity.

In the server machine 10 different from the client terminal 30, an utterance sentence analysis unit 11, a database search unit 12, and a user interface application 13 operate. The user interface application 13 has a function of receiving an utterance sentence from the utterance sentence input unit 31, analyzing the utterance sentence using the utterance sentence analysis unit 11, searching a background knowledge database 23 using the database search unit 12, and controlling the display screen 32, and plays a role of control module of the entire system.

On the storage device 20, there are a document file group 21, which is created and accumulated by various activities by a user who participates in or is likely to participate in communication, a background knowledge extraction unit 22, and the background knowledge database 23. The document file group 21 includes files accumulated in an arbitrary management target area, the files being defined by various activities by a user who participates in or is likely to participate in communication. These components do not need to exist on the same storage device 20. An arbitrary function included in the storage device 20, for example, the background knowledge extraction unit 22 or the background knowledge database 23 and the server machine 10 may be integrated.

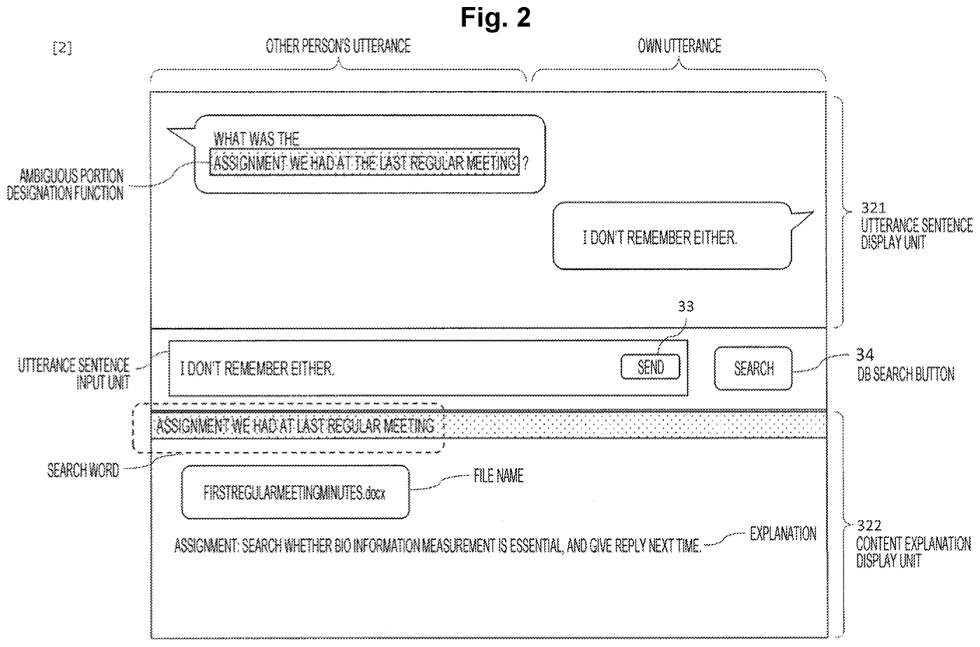

The ambiguous portion designation function provides a function of designating an ambiguous portion when a participant in communication finds an ambiguity of an entity referred to by a part of an utterance. For example, as illustrated in FIG. 2, in a case of failing to recall the content of “assignment we had at last regular meeting” included in other person's utterance, the part in utterance display is highlighted, and a DB search button 34 is pressed down to ask for a content explanation.

Note that the utterance sentence input unit 31 is displayed on the display screen 32 as illustrated in FIG. 2 in a case where dialogue is performed on a text basis. At this time, when a send button 33 is pressed down, the text input to the utterance sentence input unit 31 is transmitted as the user's own utterance and displayed on the utterance sentence display unit 321. In a case of performing dialogue on a voice basis, the utterance sentence input unit 31 is not displayed on the display screen, and the recognition result of the voice input through the microphone is displayed directly as an utterance sentence on the utterance sentence display unit 321.

The utterance sentence analysis unit 11 sequentially inputs utterance sentences uttered by all participants in communication, and performs structural analysis and the like of the utterance sentences in preparation for a database search operation described later. Specifically, regarding a portion that is a target of ambiguity resolution, its noun part (called a main noun. In the example of FIG. 2, “assignment” corresponds to it) and a part that modifies the noun part (in the example of FIG. 2, “we had at last regular meeting” corresponds to it) are identified. Furthermore, unuttered information that does not appear in utterance, such as who the participant in the communication is or when the communication takes place, is collected.

Furthermore, context analysis is performed using a set of past utterance sentences and the above-described unuttered information as necessary. Based on the context analysis, ellipsis analysis for specifying a subject or an object omitted in the utterance sentence, or reference resolution of a pronoun is performed. Through these processing, information necessary for the search processing of the background knowledge database 23 is collected.

The background knowledge extraction unit 22 refers to content of a document file group created and accumulated by various activities by a user who participates in or is likely to participate in communication, extracts information to be background knowledge of communication, and stores the information in the background knowledge database 23. The background knowledge database 23 holds background knowledge generated by the background knowledge extraction unit 22 in a form of database searchable from the outside.

The database search unit 12 searches the background knowledge database 23 using the information collected by the utterance sentence analysis unit 11, and specifies a document file that explains the entity of the noun designated by the ambiguous portion designation function and an explanation in the document file. The content explanation display unit 322 shapes the information specified by the database search unit 12, that is, a description sentence for the noun designated as an ambiguous portion, and a document file including the description sentence into a form easy for the user to read, and displays the document file on the display screen 32.

### Advantageous Effects of Invention

Since the present invention is configured as described above, it achieves the following effects.

Thanks to the ambiguous portion designation function, the user who has found an expression whose meaning is difficult to understand in other person's utterance can specify a part that requires a content explanation and activate the search processing by the system of the present invention without directly asking a question to the utterer of the utterance.

The background knowledge extraction unit 22 and the background knowledge database 23 can accumulate background knowledge that can be the ground of content explanation of the ambiguous expression.

The utterance sentence analysis unit 11 and the database search unit 12 make it possible to automatically and promptly search and specify the information that serves as content explanation of the ambiguous expression on the basis of the background knowledge without relying on memorization by the utterer.

The content explanation display unit 322 can present the content explanation information in a form that the user can understand.

From the above, the present invention can solve the problem of the present disclosure.

### First Embodiment

An embodiment of the invention will be described with reference to the drawings on the basis of a first embodiment.

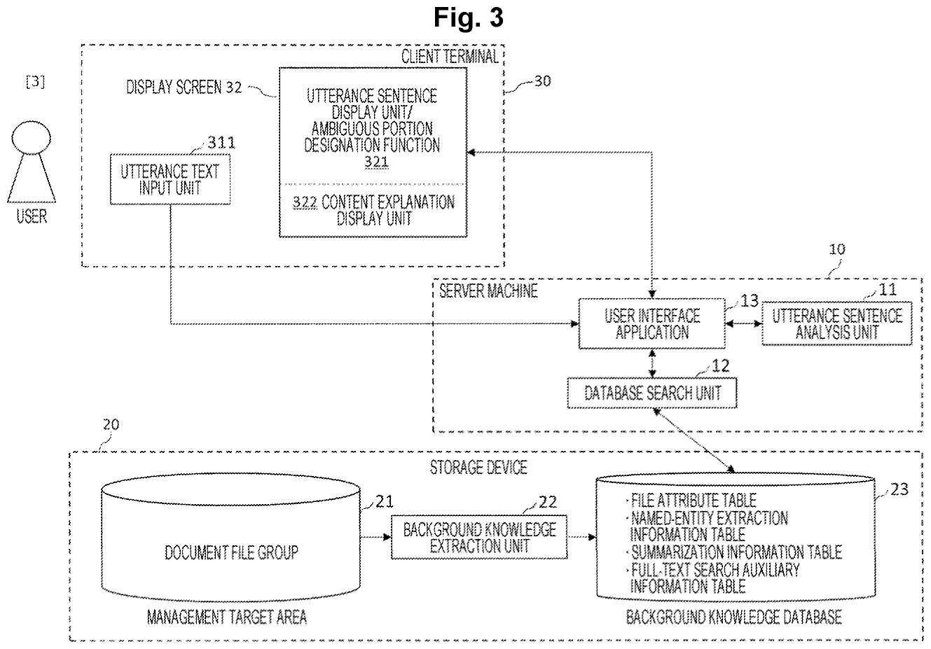

FIG. 3 is a view illustrating the overall configuration of the present embodiment. In the present embodiment, the utterance sentence input unit 31 in the communication system illustrated in FIG. 1 is an utterance text input unit 311 to which the user inputs utterance by text input, and furthermore, a table of a database included in the background knowledge database 23 in FIG. 1 is embodied in four types of tables (file attribute table, named-entity extraction information table, summarization information table, and full-text search auxiliary information table). Note that the display screen 32 in FIG. 3 is similar to that illustrated in FIG. 2.

First, an outline of the operation performed on the display screen of FIG. 2 by the user when using the communication system of the present first embodiment and the operation of each unit in FIG. 3 that occurs corresponding to the operation will be described.

In a case of making an utterance, the user inputs a text sentence having a content desired to utter into the utterance sentence input unit 31 (corresponding to the utterance text input unit 311 in FIG. 3) of the user's own client terminal illustrated in FIG. 2, and presses down the send button 33 in the figure. By pressing down the send button 33, the text sentence input to the utterance sentence input unit 31 and an identifier (methods for generating and managing this identifier are not defined in the present description) for identifying the utterer are transmitted to the user interface application 13 of the server machine 10 in FIG. 3.

The user interface application 13 that has received the text sentence and the identifier of the utterer transmits the received text sentence and the identifier of the utterer to the utterance sentence display units 321 of all the client terminals 30, and adds the information to the utterance history. The user interface application 13 accumulates therein all utterances by all users as an utterance history so that complement of an ellipsis portion in the utterance and reference resolution can be performed (described later) as necessary.

The utterance sentence display unit 321 of each client terminal 30 has received the text sentence and the identifier of the utterer, and if the received identifier of the utterer is the identifier corresponding to the user of the terminal, displays the received text sentence on the own utterance part of the utterance sentence display unit 321 in FIG. 2. If the received identifier of the utterer is not the identifier corresponding to the user of the terminal, the received text sentence is displayed on an utterance part of other person in the utterance sentence display unit 321 in FIG. 2.

Through the above procedure, communication progresses while the content of the utterance of each user is shared. Having found an ambiguous noun whose entity or content cannot be specified in an utterance sentence by other person or the user himself/herself during progress of communication, the user highlights the portion as in the example of FIG. 2 using the ambiguous portion designation function, and presses down the DB search button 34. By pressing down the DB search button 34, the text sentence of the utterance, the text part designated as an ambiguous portion, and an identifier for identifying the utterer of the utterance are transmitted to the user interface application 13 of the server machine in FIG. 3.

The user interface application 13 having received this information uses the utterance sentence analysis unit 11 to execute structural analysis and information collection of an utterance sentence necessary for searching the background knowledge database 23. Then, the pieces of information (the main noun, modifier part, and modifier phrase of the part designated as an ambiguous portion) necessary for searching the background knowledge database 23 are acquired, and the acquired information is passed to the database search unit 12.

The database search unit 12 having received the above information searches the table of the background knowledge database 23 using the received information (details will be described later), and transmits the acquired check result (id of the document (e.g., document_id described later), file name, sentence extracted from the document) to the user interface application 13. The user interface application 13 forwards the received search result to the content explanation display unit 322 of each client terminal 30.

The content explanation display unit 322 displays the received search result on the display screen 32. As illustrated in FIG. 2, the content explanation display unit 322 displays the file name of the received search result and the sentence extracted from the document on the screen as the explanation, with the text part designated as the ambiguous portion being used as the title. The document id of the search result is used for specifying the file in order to provide a hyperlink from the display part of the file name to the entity of the file.

The above is an outline of the operation performed on the display screen of FIG. 2 and an operation of each unit in FIG. 3 that occurs correspondingly. Hereinafter, each unit in FIG. 3 will be described in detail.

The background knowledge database 23 is a relational database that holds information extracted by the background knowledge extraction unit 22 described later from the document file group 21 in the management target area described earlier. The background knowledge database 23 includes tables of four types of relational databases, i.e., file attribute of the document file, named-entity extraction information, summarization information, and full-text search auxiliary information.

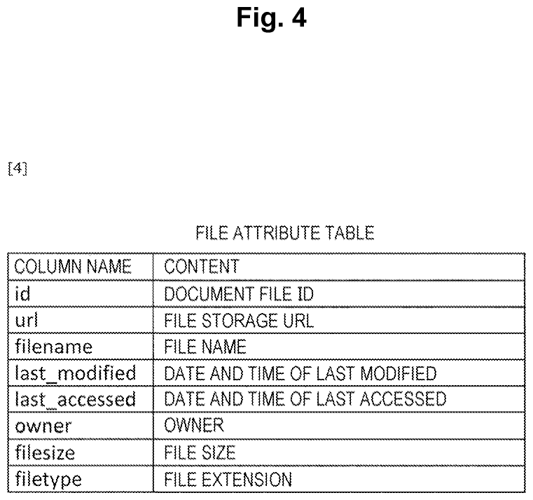

The file attribute table is a table storing file attribute information of each document file in the management target area described earlier. The file attribute is attribute information of each file managed by a file system of an operating system (OS) of a computer system in which the document file group 21 is stored. The file attribute table has a record corresponding to each document file on a one-to-one basis. Each record has the column illustrated in FIG. 4. Each column holds data of content described in the figure. id column is a primary key (pk) of the relational database, that is, the numeral for uniquely identifying a record, and corresponds to each document file on a one-to-one basis. id described in id column of the file attribute table corresponds to document_id.

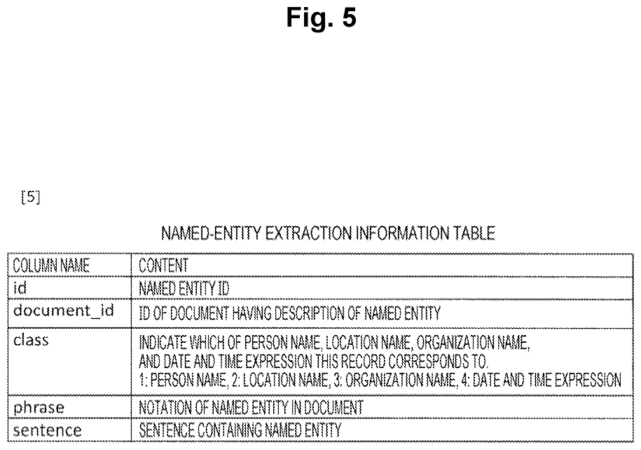

The named-entity extraction information table is a table storing named entities extracted from the body of each document file in the management target area described earlier. The named entities refer to description corresponding to person names, location names, organization names, and date and time expressions. The named-entity extraction information table has a record corresponding to each document file on a one-to-one basis. Each record has the column illustrated in FIG. 5. Each column holds data of content described in the figure. id column is pk that uniquely identifies a record, and corresponds to each document file on a one-to-one basis.

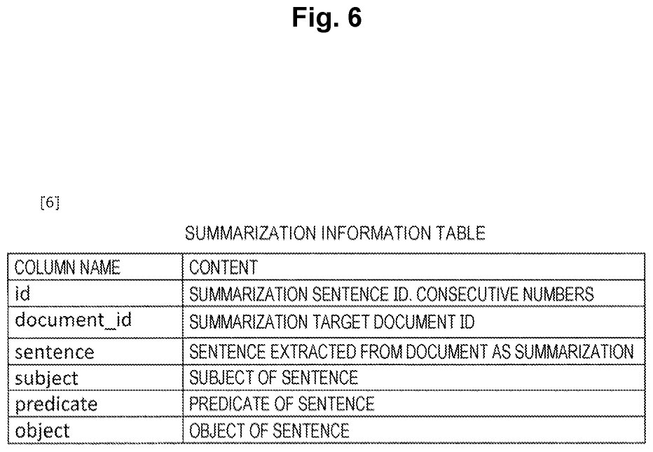

The summarization information table stores a summarization sentence of the body of each document file in the management target area described earlier. The summarization information table has a record corresponding to each document file on a one-to-one basis. Each record has the column illustrated in FIG. 6. Each column holds data of content described in the figure. id column is pk that uniquely identifies a record, and corresponds to each document file on a one-to-one basis.

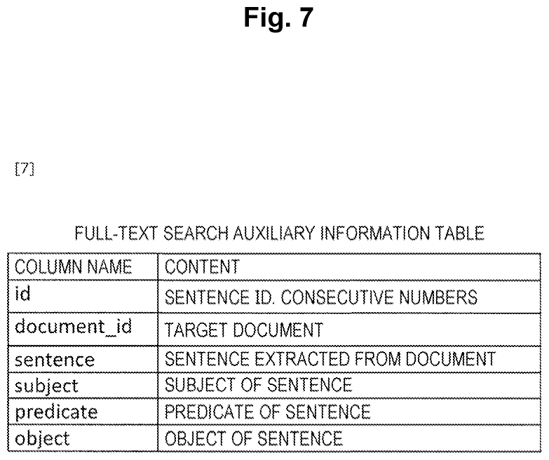

The full-text search auxiliary information table stores the body of each document file in the management target area described earlier. The full-text search auxiliary information table has a record corresponding to each document file on a one-to-one basis. Each record has the column illustrated in FIG. 7. Each column holds data of content described in the figure. id column is pk that uniquely identifies a record, and corresponds to each document file on a one-to-one basis.

The background knowledge extraction unit 22 is implemented as a software process that operates in the background, and the operation is activated at predetermined regular time intervals. At the time of operation, the background knowledge extraction unit 22 examines the document file group present in the management target area described earlier, extracts information from a document file if there is a new document file for which information extraction has not been performed so far or a document file whose content has been updated from the time point of past information extraction investigation, and writes the information into the above-described five types of tables constituting the background knowledge database 23.

Individual document files in the management target area can be uniquely identified by a combination of a value of url column and a value of filename column in the file attribute table. Therefore, when finding a document file that cannot be expressed by a combination of these values, the background knowledge extraction unit 22 regards the file as a new document file.

When finding a new document file, the background knowledge extraction unit 22 first creates a new record for storing information regarding the document file in the file attribute table of the background knowledge database 23. Then, the background knowledge extraction unit 22 allocates, to the document file, a unique id (this id may be referred to as document_id) different from other document files, and writes the value into the id column. Moreover, the background knowledge extraction unit 22 stores an appropriate value into another column in the created record. A method for obtaining information regarding this value will be described later.

The background knowledge extraction unit 22 similarly creates a new record for storing information regarding the document file also for the named-entity extraction information table, the summarization information table, and the full-text search auxiliary information table. The background knowledge extraction unit 22 writes, into the id column of the newly generated record, the same value as the value allocated at the time when creating the record in the file attribute table. The background knowledge extraction unit 22 stores an appropriate value into another column of the created record, and a method for obtaining information regarding this value will be described later.

In a case where the background knowledge extraction unit 22 finds a file whose date and time of the last modification given by the OS file system are later than those of the value of last_modified column in the file attribute table, the background knowledge extraction unit 22 regards that the content of the document file has been updated after the time point of the previous information extraction operation.

When finding a document file with updated content, the background knowledge extraction unit 22 updates, based on the content of the document file, the values of other columns for the record having the value of id corresponding to the document file regarding the table of the background knowledge database 23. A method for obtaining information regarding the value to be stored in the column is similar to that when a document file is newly found, and will be described later.

The above is the outline of the operation of the background knowledge extraction unit 22. Next, a method in which the background knowledge extraction unit 22 extracts, from the document file, information stored in each table of the background knowledge database 23 will be described.

The value of each column in the record of the file attribute table is extracted by accessing the file system of the OS.

The named-entity extraction information table refers to the body of the document file, extracts named entities (person names, location names, organization names, and date and time) from the body, and stores the type of the named entity into class column in the record and the notation of the extracted named entity into the phrase column in the record. For extraction of named-entity information, an existing language processing technology (e.g., see Non Patent Literature 1) that has the function is used. It is assumed that there is a dedicated dictionary that covers named entities.

For the summarization information table, the body of a document file is summarized using a document summarization algorithm, and the summarization sentence is stored in sentence column. Then, predicate argument structural analysis is performed on the summarization sentence, and the result is stored in subject, predicate, and object columns. Also for the document summarization algorithm, an existing language processing technology (see, for example, Non Patent Literature 2) that requires the function is used.

Also for the full-text search auxiliary information table, the body of a document file is stored in sentence column, and the result of performing the predicate argument structural analysis on the body is stored in subject, predicate, and object columns.

Hereinafter, a method for obtaining content explanation information on a designated ambiguous portion in utterance using these background knowledge databases 23 will be described.

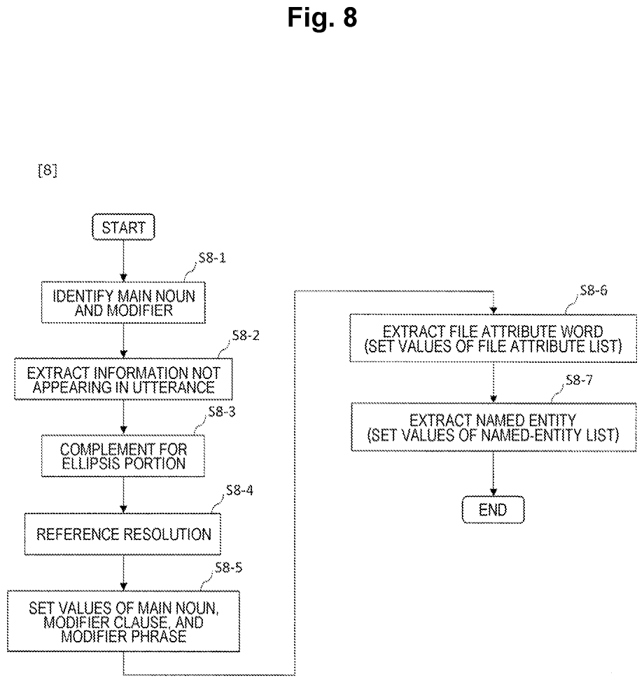

When a part to be searched is designated by the ambiguous portion designation function, the utterance sentence analysis unit 11 executes structural analysis and information collection of the utterance sentence necessary for searching the background knowledge database 23. FIG. 8 illustrates the flow.

First, for a part designated as an ambiguous portion, a main noun and a modifier part that modifies the main noun are identified (step S8-1).

Information that does not appear in the utterance, specifically, information on the utterer and the utterance time is extracted (step S8-2). To do this, the user interface application 13 running on the system accesses information identifying each user and information regarding time management.

Next, in a case where the modifier part identified in step S8-1 contains ellipsis of a subject or an object or a pronoun, complementation for the ellipsis portion or reference resolution is performed using an ellipsis analysis technology or a reference resolution technology (steps S8-3 and S8-4). Existing language processing technology is used for ellipsis analysis and reference resolution (see, for example, Non Patent Literature 3).

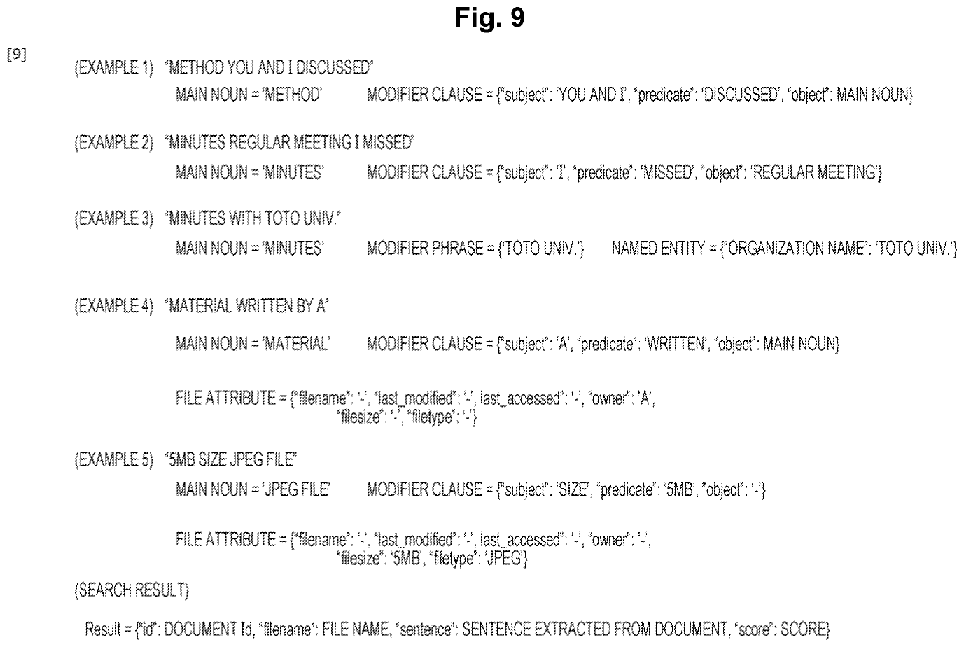

By the processing so far, the contents of the main noun and the modifier part (which may be a clause or a phrase) that modifies the main noun are determined. The determined main noun is stored as the value of the variable ‘main noun’. The determined modifier phrase is stored as the value of the variable ‘modifier phrase’. The modifier clause is stored in the variable ‘modifier clause’. The modifier clause variable has a structure including tabs representing subject, predicate, and object (object of predicate) and a set of values thereof, and the content determined by analysis is stored as a value of each tab. FIG. 9 illustrates an example in which words and phrases designated as ambiguous portions and an analysis result thereof are stored in variables for background knowledge database search.

In the processing of step S8-6 and subsequent steps in FIG. 8, words corresponding to file attribute and named entity are extracted and stored in variables of ‘file attribute list’ and ‘named-entity list’, respectively. Each variable has a structure illustrated in FIG. 9. Here, in extraction of words representing file attributes and named entities, it is assumed that there is a dictionary that holds a list of such words.

In FIG. 9, ‘Result’ variable is a variable for storing a result of database search, that is, one of the content possibilities displayed on the content explanation display unit 322. This variable has a structure including three tabs of document_id, filename, and sentense, and a set of values thereof. Here, ‘document_id’ is a value of id column of the file attribute table, and is an id specific to each document file. ‘filename’ is a file name of the document file represented by document_id, and is the same as the value of filename column in the file attribute table. ‘sentense’ is a sentence stored in sentence column of the record hit by search of each table. The variable ‘ResultList’ is a variable having a structure capable of storing a plurality of Result variables, and is used to treat all the possibilities of the explanation information obtained as a result of search of each table.

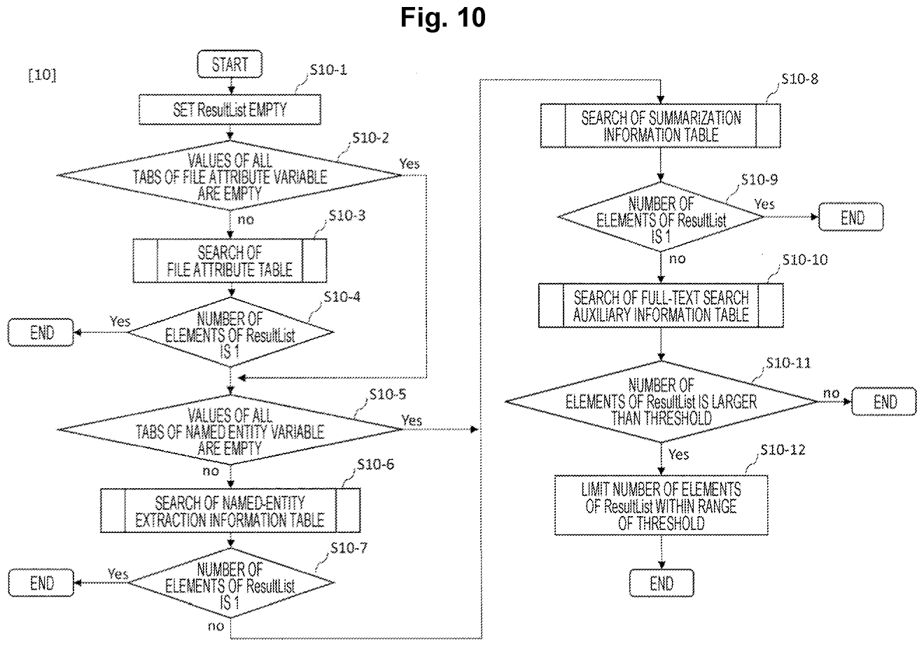

When the preprocessing of FIG. 8 ends, the database search unit 12 having received the result from the utterance sentence analysis unit 11 executes search of the background knowledge database 23. FIG. 10 illustrates the flow. As illustrated in the figure, the database search unit 12 searches the file attribute table (S10-3), the named-entity extraction information table (S10-6), the summarization information table (S10-8), and the full-text search auxiliary information table (S10-10) in this order. This is to speed up the specification of the result by first searching a table that stores information considered to have a stronger degree of limitation in meaning.

After each table of the file attribute table, the named-entity extraction information table, and the summarization information table is searched, a list of results, that is, the number of elements of ResultList, which is a variable storing possibilities for explanation information, is examined (S10-4, S10-7, S10-9). If it is 1, it is determined that the explanation information has been determined, and the search processing ends. Otherwise, the processing proceeds to the subsequent processing. Note that, as described in the explanation part of the search processing of each table, in a case where the number of elements of the list of search results becomes 0, ResultList is returned to the state before the table search, and the processing proceeds to the search of the next table.

After the search of the last full-text search auxiliary information table, when the number of elements of ResultList is larger than a predetermined threshold (Yes in S10-11), that is, the number of possibilities for explanation information is too large, the result is narrowed within the range of the threshold, and the processing ends (step S10-12).

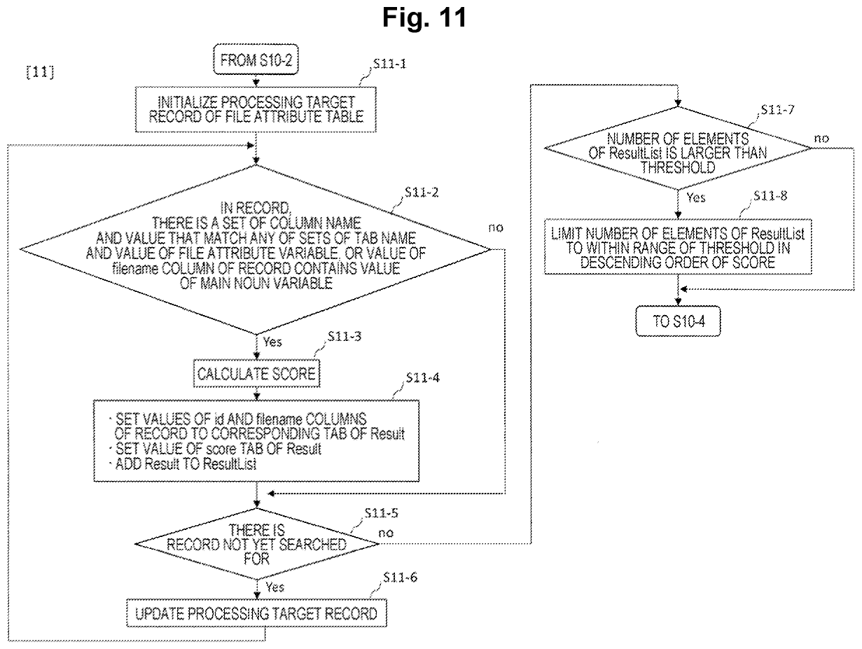

Next, a specific search procedure of each table will be described. First, search processing of the file attribute table (step S10-3 in FIG. 10) will be described with reference to FIG. 11.

The search processing is executed while referring to each record in the table one by one. In a case where there is at least one column in which the column name and its value match any of the sets of the tab name of the file attribute list and its value (step S11-2), or in a case where the value of filename column of the record includes the value of a main noun variable, the document file represented by the value of id column of the record is regarded as a possibility for explanation information, and the value of id column is set to Result variable. Then, Result is added as an element of ResultList (step S11-4). Note that since there is no column storing the sentence of the document file in the record of the file attribute table, no value is stored in sentence tab of Result variable.

A score serving as a reference of the priority order between possibilities for the search result is calculated for the possibility (step 11-3). The value of this score is stored as the value of score tab of Result variable in step S11-4. Methods of calculating the score may include a method of increasing the score as the number of columns matching the set of the tab name of the file attribute list and its value increases, but a specific method thereof is not defined in the present description.

When the search for all records ends, it is examined whether the number of elements of ResultList falls within a range of a predetermined threshold (step S11-7). If it is within the range, the search processing of the file attribute table ends, and the process returns to step S10-4 of FIG. 10.

In a case where the number of elements of ResultList does not fall within the threshold in the examine in step S11-7 (Yes in S11-7), the elements are sequentially selected from one with high score with reference to the value of score tab, and the number of elements of ResultList falls within the threshold in such a manner that the element with low score is deleted (step S11-8). This is to prevent the number of search results to be finally displayed on the content display unit from excessively increasing.

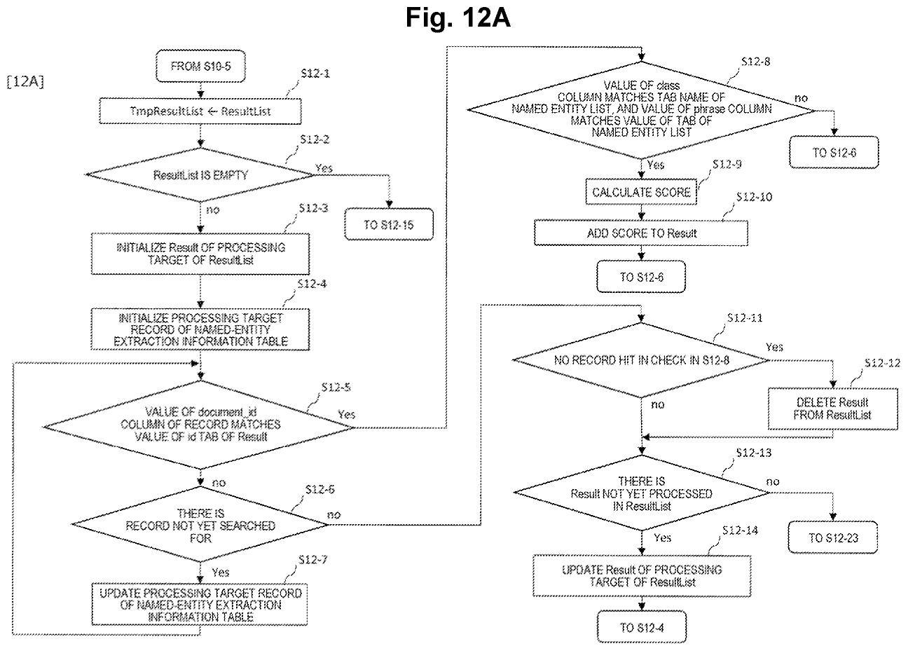

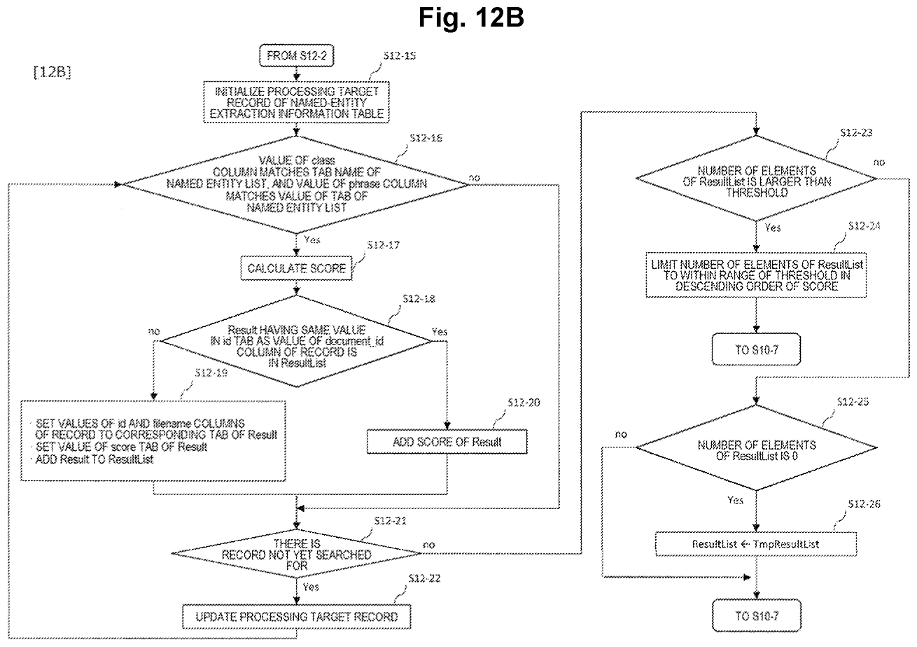

The above is the search processing of the file attribute table. Next, the search processing of the named-entity extraction information table (step S10-6 in FIG. 10) will be described with reference to FIGS. 12A and 12B.

In the named-entity extraction information table (and search processing of subsequent tables), the number of elements of ResultList in which the result of search processing of preceding tables is stored is not increased, and processing of further narrowing down is performed.

That is, in order one by one for each Result in ResultList (Steps S12-3, S12-13, and S12-14), it is checked, for each record in the table, whether the value of class column matches the tab name of the named-entity list and the value of phrase column matches the value of the tab of the named-entity list (step S12-8). In a case of matching, the score is added to the Result to increase the priority of remaining as a possibility for the search result (S12-9, S12-10). However, a record whose value of document_id column does not match the value of id tab of the Result, that is, a record of a document different from the document indicated by Result is no longer a target of check in step S12-8 (steps S12-5 to S12-7).

Result for which no record has been hit in the check in step S12-8 at the time point when the records in the table have gone through (Yes in step S12-11) is deleted from ResultList (step S12-12) and is excluded from the possibilities for the search result.

Note that in a case where ResultList at the time point of being passed as a result of search processing of the file attribute table of the previous stage is empty (step S12-2), the processing of step S12-15 and subsequent steps is executed. In this case, for each record in the table, the same check as in step S12-8 is performed (step S12-16). In a case of being hit, it is determined whether or not the document indicated by the record is already included in ResultList (step S12-18). If the document is not included, a new Result is added (step S12-19). If the document is already included, a score of the Result is added (step S12-20).

It is similar to the case of the search processing of the file attribute table that the number of elements of ResultList falls within the range of the threshold (Steps S12-23, S12-24) in a case where the processing for all Result and records in the table ends. However, in the search processing of the named-entity extraction information table, when the number of elements of ResultList becomes 0 (step S12-25), it is returned to ResultList saved at the time point of step S12-1, and the processing ends (S12-26).

In a case where Result, that is, the search result has not yet been narrowed down to one in a stage where the search of the named-entity extraction information table ends (step S10-7 illustrated in FIG. 10), the process proceeds to the search processing of the summarization information table (step S10-8).

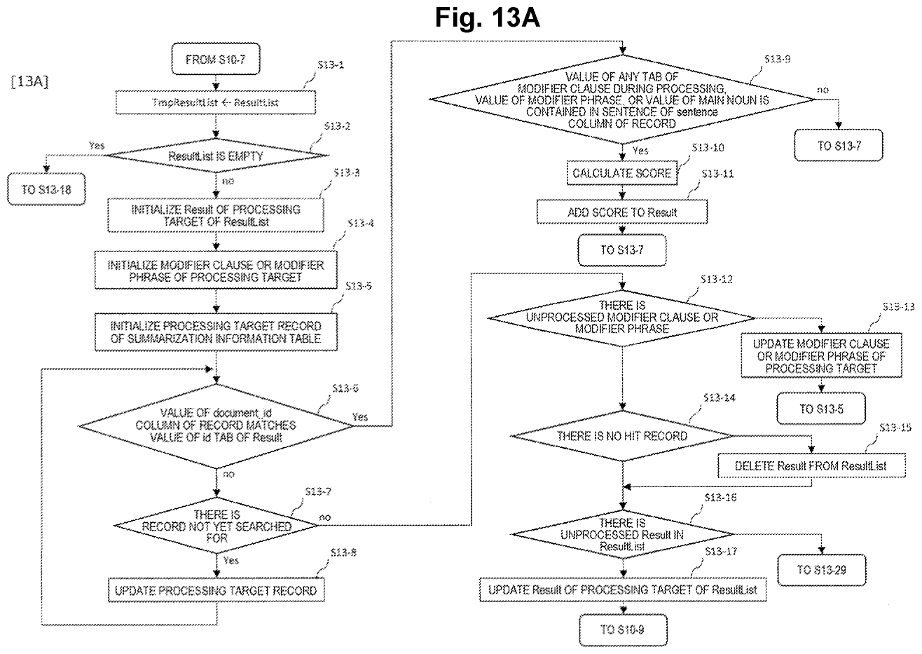

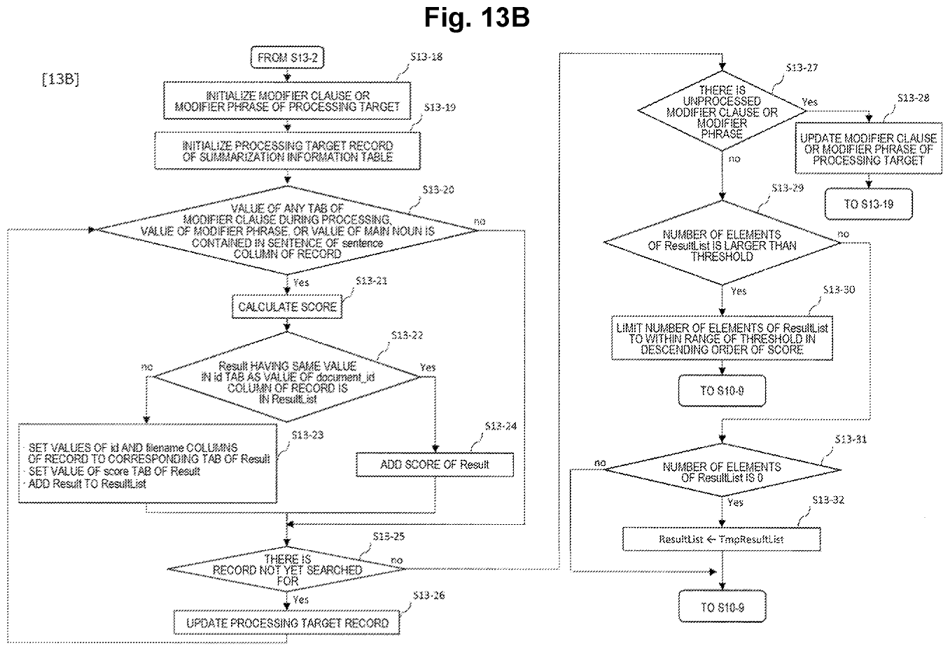

FIGS. 13A and 13B illustrate search processing of the summarization information table. In the search processing of this table, since there may be a plurality of modifier clause variables or modifier phrase variables to be searched, the search processing is executed one by one for each of them (steps S13-4, S13-12, and S13-13).

For each record, it is regarded as a hit (steps S13-9 to S13-11) when any one of the values (modifiers) of the tabs of the modifier clause being processed, the value (modifier) of the modifier phrase being processed, or the value of the main noun is included in a sentence stored as the value of sentence column of the record.

Methods of score calculation of hit record (step S13-10) may include guidelines such as making the score higher as the number of modifiers included in a sentence of sentence column is larger, and making the score higher as the value of the same column name as the tab name (subject, predicate, object) of the modifier clause variable matches, but the guidelines are not defined in the present description.

In a case where Result, that is, the search result has not yet been narrowed down to one in a stage where the search of the summarization information table ends (step S10-9 illustrated in FIG. 10), the process proceeds to the search processing of the full-text search auxiliary information table (step S10-10 illustrated in FIG. 10).

Note that in a case where ResultList at the time point of being passed as a result of search processing of the named-entity extraction information table of the previous stage is empty (step S13-2), the processing of step S13-18 and subsequent steps is executed. In this case, for each record in the table, the same check as in step S13-9 is performed (step S13-20). In a case of being hit, it is determined whether or not the document indicated by the record is already included in ResultList (step S13-22). If the document is not included, a new Result is added (step S13-23). If the document is already included, a score of the Result is added (step S13-24).

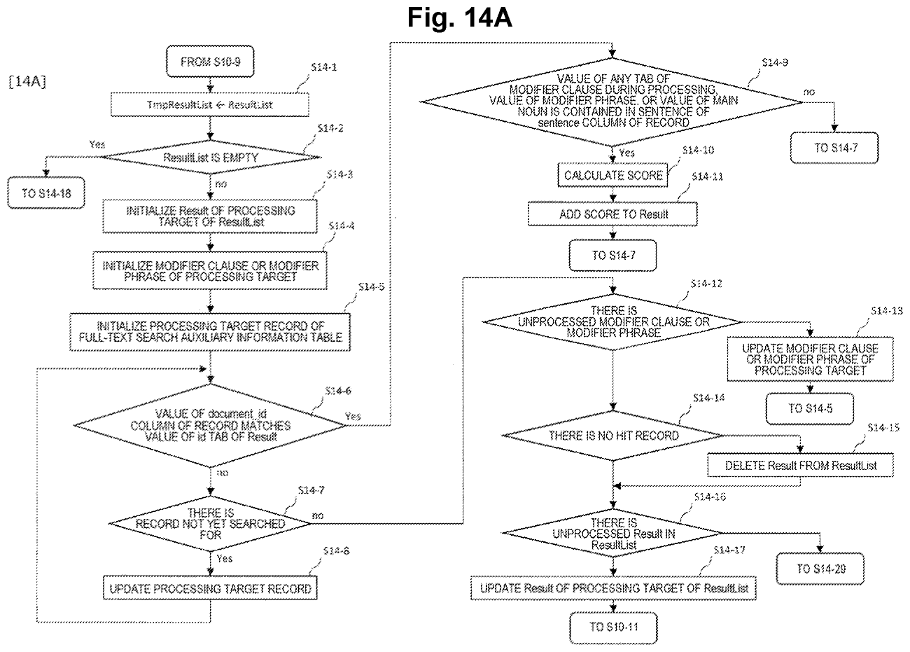

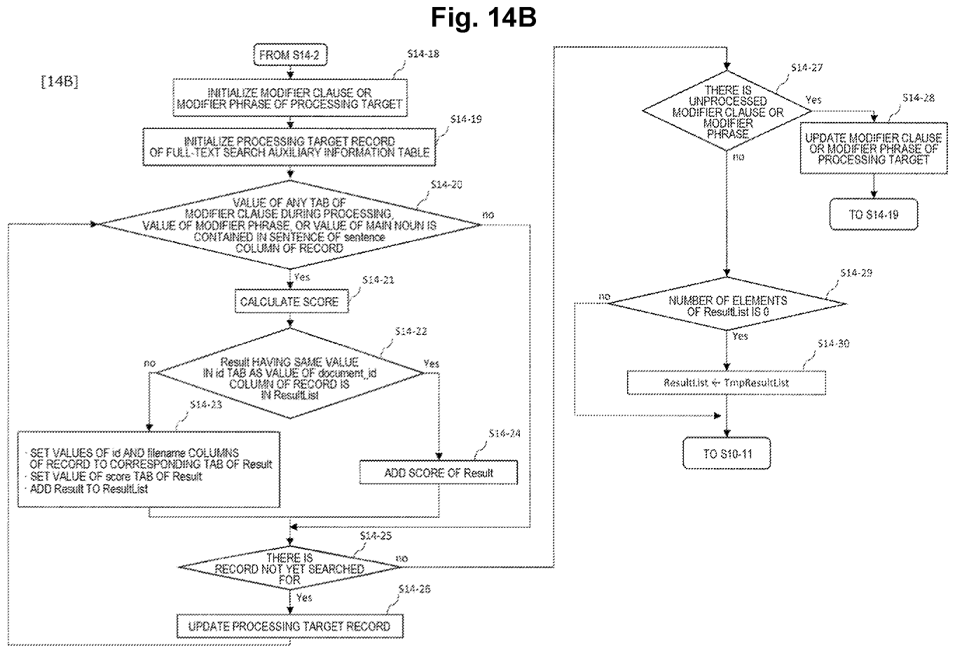

FIGS. 14A and 14B illustrate search processing of the full-text search auxiliary information table. The content of the search processing of this table is the same as that of the summarization information table described in FIGS. 13A and 13B. In a case where Result, that is, the search result is larger than the threshold in a stage where the search of the full-text search auxiliary information table ends (step S10-11 illustrated in FIG. 10), the number of elements of ResultList is narrowed down to the range of the threshold (step S10-12 illustrated in FIG. 10), and then the search processing of all tables ends. ResultList at this time point is displayed on the content explanation display unit 322 as a final search result.

When the search processing of database ends, the user interface application 13 receives ResultList, which is a search result, and displays the content onto the content explanation display unit 322. The outline of the result display is as illustrated in FIG. 2. In display, the value of filename tab of Result variable is displayed in the part of the file name of the display screen 32, and the value of sentence tab is displayed in the part of the explanation. When a plurality of Result variables are stored in ResultList, that is, when there are a plurality of possibilities for explanation information, all possibilities are displayed on the content explanation display unit.

### Second Embodiment

The present embodiment is the communication system according to the first embodiment, the communication system including a voice recognition function of inputting, by voice input, utterance of a user who is a communication participant, identifies the input voice, converts it into text, and treats the text.

Instead of utterance text input unit 311 of the first embodiment, a voice recognition unit that inputs a user's utterance voice, recognizes it, and converts it into text is included, and the other parts are the same as those of the first embodiment. The voice recognition function is implemented by application of software as described in Non Patent Literature 4, for example.

### Third Embodiment

The present embodiment is the system according to the first embodiment or the second embodiment, including the content explanation display unit 322 configured to have a function of displaying explanation content of an ambiguous portion only to the user who has designated the ambiguous portion, and a function of displaying it in a form shared by other users.

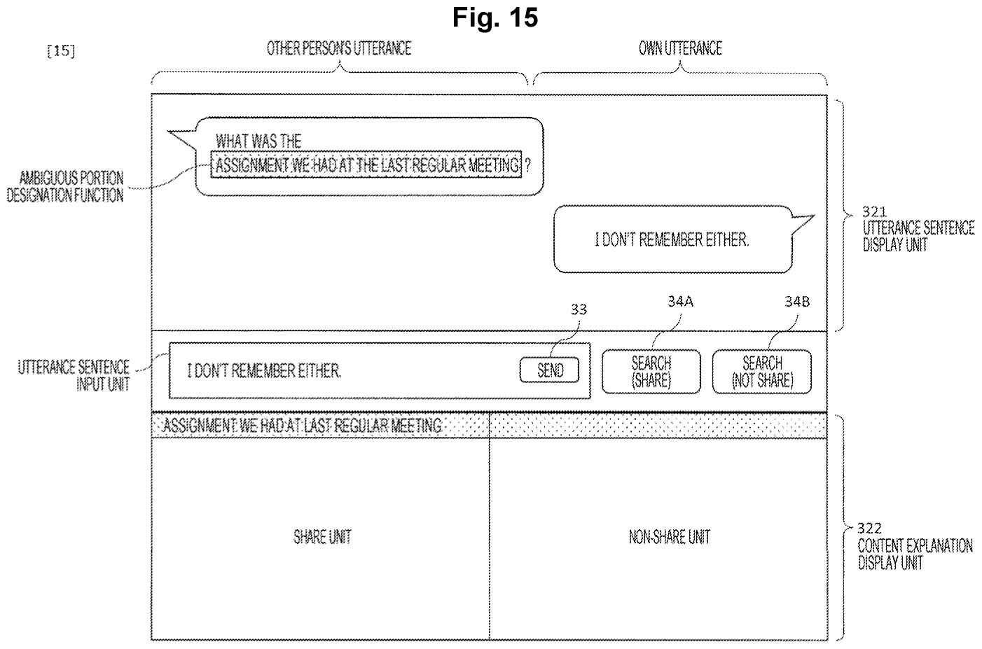

FIG. 15 illustrates an example of the content explanation display unit 322 in the present embodiment. The content explanation display unit 322 includes a share DB search button 34A and a non-share DB search button 34B instead of the DB search button 34 illustrated in FIG. 2. The share DB search button 34A and the non-share DB search button 34B each have a share selection function of selecting whether or not to share explanation content of the designated portion with other users in ambiguous portion designation. In a case where sharing is selected by pressing down the share DB search button 34A, the explanation content is displayed on share units of the content explanation display units of the client terminals of all users. In a case where non-sharing is selected by pressing down the non-share DB search button 34B, the explanation content is displayed on non-share units of the content explanation display units of the client terminals of the users.

The other parts are identical to those of the first embodiment or the second embodiment.

### INDUSTRIAL APPLICABILITY

The present disclosure can be applied to the information communication industry.

### REFERENCE SIGNS LIST

10 server machine
11 utterance sentence analysis unit
12 database search unit
13 user interface application
20 storage device
21 document file group
22 background knowledge extraction unit
23 background knowledge database
30 client terminal
31 utterance sentence input unit
311 utterance text input unit
32 display screen
321 utterance sentence display unit
322 content explanation display unit
33 transmission button
34 DB search button
34A share DB search button
34B non-share DB search button

1. An utterance understanding support system that is a communication system via a computer network, the utterance understanding support system comprising:
a processor; and
a storage medium having computer program instructions stored thereon, when executed by the processor, perform to:
refers to content of a file group of a management target area including a document file created or accumulated by an activity of a communication participant, and extracts information serving as background knowledge of communication;
holds, in a form of database, background knowledge extracted by the background knowledge extraction unit;
performs structural analysis of each utterance sentence having been input and context analysis based on an utterance history when an utterance by a user who is a communication participant is input by text input;
receive a designation of a part of the utterance as an ambiguous portion;
searches the background knowledge database for specifying an entity referred to by a noun included in the ambiguous portion; and
displays, on a screen, information describing an entity referred to by a noun included in the ambiguous portion, the entity being specified by a result of the search.

2. The utterance understanding support system according to claim 1 comprising:
a voice recognition function of identifying input voice and converting the voice into text, wherein the computer program instructions performs structural analysis of an utterance sentence of a user converted into text by the voice recognition function and context analysis based on an utterance history.

3. The utterance understanding support system according to claim 1 comprising:
a function of displaying content explanation of the ambiguous portion only on a client terminal of a user who has designated the ambiguous portion, and a function of sharing the content explanation of the ambiguous portion with client terminals of other users.

4. An utterance understanding support method, comprising:
an utterance sentence analysis unit performing structural analysis of each utterance sentence having been input and context analysis based on an utterance history when an utterance by a user who is a communication participant is input by text input;
a database search unit searching a background knowledge database in which background knowledge of communication is held in a form of database in order to specify an entity referred to by a noun included in the ambiguous portion when a part of an utterance sentence by a communication participant is designated as an ambiguous portion in a client terminal that is a communication participant; and
a user interface application displaying, on a client terminal in which the ambiguous portion is designated, information describing an entity referred to by the ambiguous portion, the entity being specified by a result of search by the database search unit.

5. (canceled)

6. A non-transitory computer-readable medium having computer-executable instructions that, upon execution of the instructions by a processor of a computer, cause the computer to:
performs structural analysis of each utterance sentence having been input and context analysis based on an utterance history when an utterance by a user who is a communication participant is input by text input;
searches a background knowledge database in which background knowledge of communication is held in a form of database in order to specify an entity referred to by a noun included in an ambiguous portion when a part of an utterance sentence by a communication participant is designated as the ambiguous portion in a client terminal that is a communication participant; and
displays, on a client terminal in which the ambiguous portion is designated, information describing an entity referred to by the ambiguous portion, the entity being specified by a result of search by the database search unit.
